(19) United States
(12) Patent Application Publication
(10) Pub. No.: US 2020/0039405 A1
(43) Pub. Date: Feb. 6, 2020

(54) VEHICLE PASSENGER SEAT FOR PASSENGER SEATING IN A VEHICLE

(71) Applicant: GM GLOBAL TECHNOLOGY OPERATIONS LLC, Detroit, MI (US)

(72) Inventors: Olga Naumenko, Grosse Pointe Woods, MI (US); Sarah E. Smith, Harrison Township, MI (US); Samir Datta, Rochester Hills, MI (US); Michael G. Schuplin, JR., Grand Blanc, MI (US); Samuel Derian, Detroit, MI (US); Daniel W. Booth, Troy, MI (US)

(21) Appl. No.: 16/051,790

(22) Filed: Aug. 1, 2018

(51) Int. Cl. B60N 2/75; B60N 2/01; B60N 2/90

(52) U.S. Cl. CPC B60N 2/777; B60N 2/914; B60N 2/01

(57) ABSTRACT

A vehicle passenger seat for side-by-side passenger seating in a vehicle includes a first seat defining a first seating position, and a raised section positioned laterally adjacent to the first seat. The raised section includes a vertical wall laterally facing and defining a lateral extent of the first seating position and the vertical wall is laterally extendable between a stowed position defining a first volume in the first seating position and a deployed position defining a second volume in the first seating position that is less than the first volume.

### FIELD

The present disclosure relates to a vehicle passenger seat for passenger seating in a vehicle.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Seats in motor vehicles are typically designed to accommodate full size adults and require significant adjustment and/or modification to adequately accommodate a small adult and/or a child. In many cases, this may only be adequately accomplished through the use of a child seat which may either be installed by an adult into the vehicle or which may be integrated into the seat. For vehicles which are owned and operated by the parent of a child, a child safety seat may be left in the vehicle in an installed condition and only infrequently removed when necessary to accommodate an adult in the seat where the child is typically seated. However, when a parent travels with their child and/or switches to another vehicle, the parent needs to carry the child seat with them and repeatedly install and remove the child seat as they switch between vehicles. This is inconvenient, a burden to carry the child seat around, and may add significant time to a trip, as the seat needs to be installed and removed every time the vehicle is switched.

This may be particularly problematic when traveling using public and/or semi-public mobility services. For example, a taxi may or may not have the seat structure which enables installation of a child seat. Further, in many jurisdictions, taxis and other public transportation systems may be exempted from accommodating a child seat. It is safest for a child to be positioned and restrained in an appropriately sized child seat, regardless of the mode of transportation.

It is desirable to provide a vehicle seat which may easily adapt to accommodate any size human whether a full-sized adult, a small adult, and/or a child.

### SUMMARY

In an exemplary aspect, a vehicle passenger seat for side-by-side passenger seating in a vehicle includes a first seat defining a first seating position, and a raised section positioned laterally adjacent to the first seat. The raised section includes a vertical wall laterally facing and defining a lateral extent of the first seating position and the vertical wall is laterally extendable between a stowed position defining a first volume in the first seating position and a deployed position defining a second volume in the first seating position that is less than the first volume.

In this manner, a vehicle passenger seat is easily configurable to accommodate passengers of varying sizes including a full-size adult, a smaller adult and/or a child. This obviates the necessity of installing a child seat into the vehicle when accommodating a child in the vehicle without interfering with the ability to comfortably accommodate a full-size adult in the same seat.

In another exemplary aspect, the seat further includes a second seat defining a second seating position laterally adjacent to the first seat and the raised section is positioned between the first and second seats.

In another exemplary aspect, the vertical wall is slidably translatable between the stowed and deployed positions.

In another exemplary aspect, the seat further includes a four-bar linkage connecting the vertical wall to the raised section.

In another exemplary aspect, the four-bar linkage includes a planar four-bar linkage.

In another exemplary aspect, the seat further includes a pneumatic bladder connecting the vertical wall to the raised section and an air pump adapted to selectively pump air into and pump air out of the pneumatic bladder to move the vertical wall between the stowed and deployed positions.

In another exemplary aspect, the seat further includes a pleated wall section connecting the vertical wall to the raised section.

In another exemplary aspect, the pleated wall section includes a plurality of bi-stable fold sections.

In another exemplary aspect, the seat further includes a slide connecting the vertical wall section to the raised section and the slide includes selectively engageable detents corresponding to each of the stowed and deployed positions.

In another exemplary aspect, the seat further includes a rotatable threaded rod engaging a threaded section in the raised section and having a distal end rotatably engaging the vertical wall.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is perspective view of a vehicle including a vehicle passenger seat for side-by-side passenger seating in accordance with an exemplary embodiment;

FIG. 2 is a perspective view of a vehicle passenger seat for side-by-side passenger seating in accordance with an exemplary embodiment;

FIG. 3 is a partial cut-away perspective view of a raised section and vertical wall of a vehicle passenger seat for side-by-side passenger seating in accordance with another exemplary embodiment;

FIG. 4 is a cross-sectional elevation view of a raised section and vertical wall of a vehicle passenger seat for side-by-side passenger seating in accordance with another exemplary embodiment;

FIG. 5 is a cross-sectional elevation view of a raised section and vertical wall of a vehicle passenger seat for side-by-side passenger seating in accordance with another exemplary embodiment;

FIG. 6 is a partial cut-away perspective view of a raised section and vertical wall of a vehicle passenger seat for side-by-side passenger seating in accordance with another exemplary embodiment;

FIG. 7 is a partial cut-away perspective view of a raised section and vertical wall of a vehicle passenger seat for side-by-side passenger seating in accordance with another exemplary embodiment;

FIG. 8 is a cross-sectional elevation view of a raised section and vertical wall of a vehicle passenger seat for side-by-side passenger seating in accordance with another exemplary embodiment;

FIG. 9 is a perspective view of a vertical wall and slide mechanism in accordance with another exemplary embodiment; and

FIG. 10 is a partial cut-away perspective view of a raised section and vertical wall of a vehicle passenger seat for side-by-side passenger seating in accordance with another exemplary embodiment.

### DETAILED DESCRIPTION

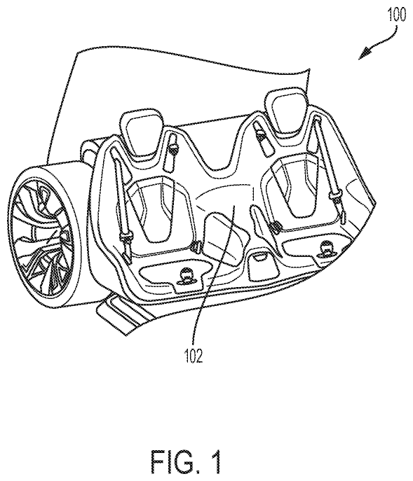

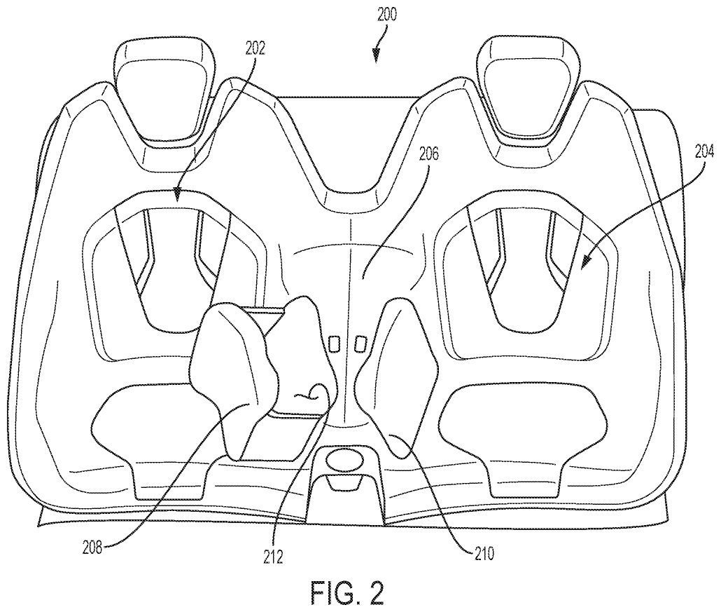

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures, FIG. 1 is a perspective view of a vehicle 100 with a vehicle passenger seat 102 for side-by-side passenger seating in accordance with an exemplary embodiment. FIG. 2 illustrates a perspective view of a vehicle passenger seat 200 for side-by-side passenger seating in accordance with an exemplary embodiment.

The vehicle passenger seat 200 includes a first seat 202 defining a first seating position and a second seat 204 defining a second seating position. The first and second seats, 202 and 204, are positioned laterally adjacent to each other. The vehicle passenger seat 200 further includes a raised section 206 that is positioned between the first seat 202 and the second seat 204. The raised section 206 includes a vertical wall 208 that is laterally extendable between a stowed position and a deployed position. In FIG. 2, the vertical wall 208 is illustrated in the deployed position. Optionally, the raised section 206 may also include another vertical wall 210 on an opposing side of the raised section 206. In FIG. 2, the vertical wall 210 is illustrated in the stowed position. The volume available for a passenger occupying the vehicle passenger seat 200 is thereby adjustable by selectively moving the vertical wall 208 between the stowed position and the deployed position. A larger, full-size person may prefer that the vertical wall 208 be positioned in the stowed position while a smaller person or child may prefer that the vertical wall 208 be positioned in the deployed position. In this manner, the width or volume of the seat may be adjusted according to the size of a passenger occupying the seat.

While FIGS. 1 and 2 illustrate a vehicle passenger seat having a first seat and a second seat positioned laterally adjacent to each other in a side-by-side configuration, it is understood that the passenger seat is not limited to any number of seating positions. For example, the passenger seat may include only a single seating position or any number of a plurality of seating positions without limitation and still be encompassed by the present disclosure.

Movement of the vertical wall 208 to the deployed position may provide access to a volume 212 in which items may be stored. Alternatively, access to the volume 212 may be restricted by providing a cover surface (not shown) which encloses the volume 212.

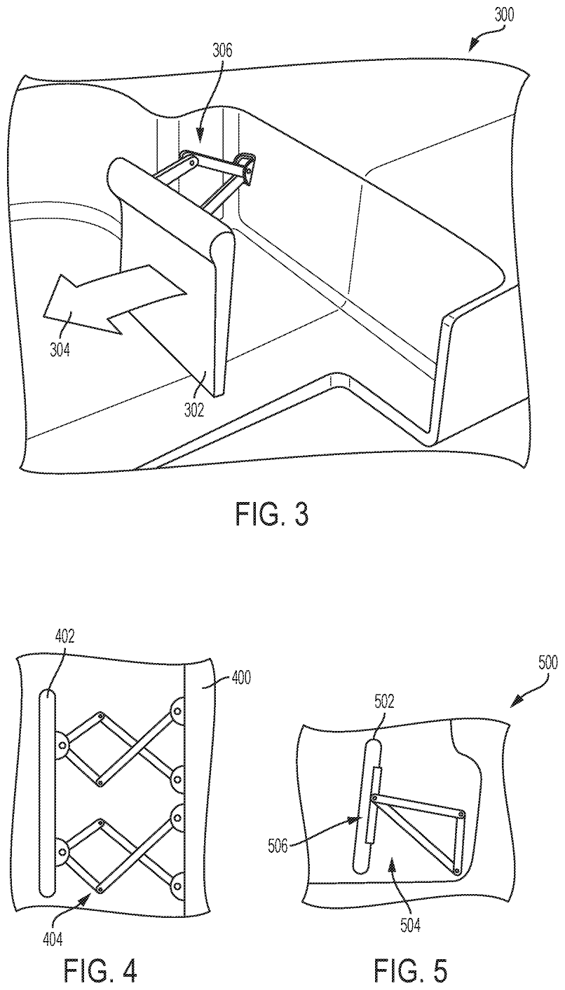

FIG. 3 illustrates a partial cut-away perspective view of a raised section 300 and vertical wall 302 of a vehicle passenger seat for side-by-side passenger seating in accordance with another exemplary embodiment. The vertical wall 302 is translatable in the direction illustrated by arrow 304 between a stowed position (not shown) and the deployed position illustrated in FIG. 3. The vertical wall 302 is connected to the raised section 300 by a four-bar linkage 306. The four-bar linkage 306 operates to maintain the orientation of the vertical wall 302 (i.e. maintaining the vertical wall 302 in a vertical orientation) while moving between the stowed and deployed positions. The four-bar linkage 306 includes a plurality of links which are pivotally hinged to each other and each of the vertical wall 302 and raised section 300. While FIG. 3 illustrates only a single four bar linkage 306 it is to be understood that the vertical wall 302 may optionally be connected to the raised section 300 by more than one four bar linkage 306.

FIG. 4 is a cross-sectional elevation view of a raised section 400 and vertical wall 402 of a vehicle passenger seat for side-by-side passenger seating in accordance with another exemplary embodiment. The vertical wall 402 is connected to the raised section 400 by a plurality of four-bar linkages 404 which may improve the stability and control over the orientation of the vertical wall 402 relative to the raised section 400 while moving between stowed and deployed positions.

FIG. 5 is a cross-sectional elevation view of a raised section 500 and vertical wall 502 of a vehicle passenger seat for side-by-side passenger seating in accordance with another exemplary embodiment. The vertical wall 502 is connected to the raised section 500 with a four-bar linkage 504. At least one of the links in the four-bar linkage 504 may be slidably connected to the vertical wall 502 as illustrated at, for example, 506 in FIG. 5.

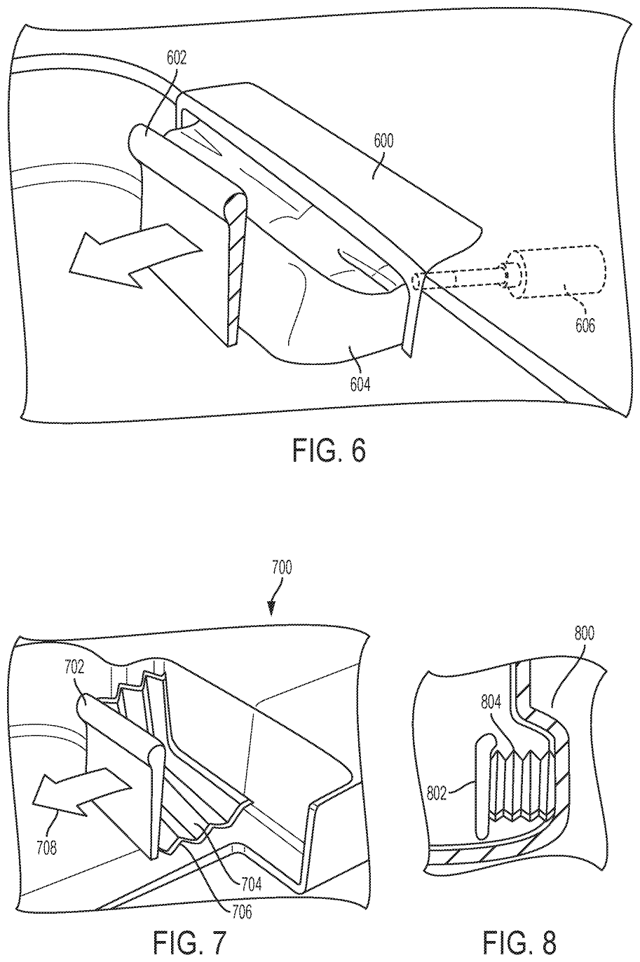

FIG. 6 is a partial cut-away perspective view of a raised section 600 and vertical wall 602 of a vehicle passenger seat for side-by-side passenger seating in accordance with another exemplary embodiment. The vertical wall 602 is connected to the raised section 600 by a pneumatic bladder 604. The pneumatic bladder 604 is in communication with an air pump 606 which is selectively actuable to inflate or deflate the pneumatic bladder 604. In this manner, the vertical wall 602 may be moved between a stowed position and a deployed position. While FIG. 6 illustrates a single air pump 606 it is to be understood that the pneumatic bladder 604 may optionally be in communication with multiple air pumps 606.

FIG. 7 is a partial cut-away perspective view of a raised section 700 and vertical wall 702 of a vehicle passenger seat for side-by-side passenger seating in accordance with another exemplary embodiment. The vertical wall 702 is connected to the raised section 700 with a pleated wall section 704. The pleated wall section 704 includes a plurality of bi-stable folds 706 which each individually may be stable in a folded configuration and/or an open configuration. The vertical wall 702 may be movable in the direction illustrated by arrow 708 between a stowed position and a deployed position by pulling and/or pushing on the vertical wall 708 to sequentially open or close each of the individual bi-stable folds 706.

FIG. 8 is a cross-sectional elevation view of a raised section 800 and vertical wall 802 of a vehicle passenger seat for side-by-side passenger seating in accordance with another exemplary embodiment. The vertical wall 802 is connected to the raised section 800 with a pleated wall section 804. The pleated wall section 804 may operate in a manner similar to the pleated wall section 704 described with respect to the embodiment illustrated in FIG. 7. However, in contrast to the pleated wall section 704 which may be open on the top to provide access to a storage volume from above, the pleated wall section 804 of FIG. 8 may completely enclose the volume between the vertical wall 802 and the raised section 800.

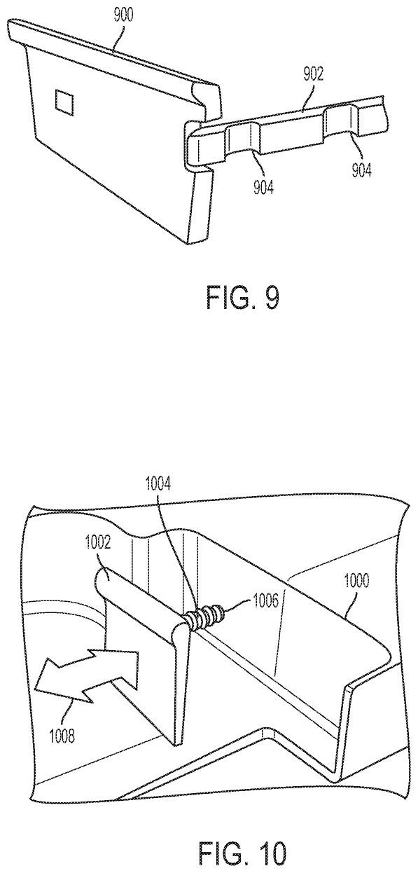

FIG. 9 is a perspective view of a vertical wall 900 and slide mechanism 902 in accordance with another exemplary embodiment. The slide mechanism 902 connects the vertical wall 900 to a raised section of a vehicle passenger seat (not shown). The slide mechanism 902 may operate and be structured in a manner similar to or identical to that of slide mechanisms which may be well known for use with drawer mechanisms. The slide mechanism 902 includes a plurality of detents 904 which may interact with the raised section (not shown) to control the position of the vertical wall 900 relative to the raised section.

FIG. 10 is a partial cut-away perspective view of a raised section 1000 and vertical wall 1002 of a vehicle passenger seat for side-by-side passenger seating in accordance with another exemplary embodiment. The vertical wall section 1002 may be rotatably connected to a distal end of a rotatable threaded rod 1004 that has a proximal end threadably engaging a threaded section 1006 in the raised section 1000. In this manner, rotation of the threaded rod 1004 causes the rod 1004 to selectively extend through the threaded section 1006 of the raised section 1000 which, in turn, causes the vertical wall 1002 rotatably connected to a distal end of the threaded rod 1004 to move in and/or out along the lateral axial direction indicated by arrow 1008. The threaded rod 1004 may be connected to a rotatable drive (not shown) which may selectively operate to cause the threaded rod 1004 to rotate as is well known in the art. While FIG. 10 illustrates a single threaded rod 1004 it is to be understood that the vertical wall section 1002 may optionally be connected to the raised section 1000 by multiple threaded rods 1004.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle passenger seat for passenger seating in a vehicle, the seat comprising:
a first seat defining a first seating position; and
a raised section positioned laterally adjacent the first seat, wherein the raised section includes a vertical wall laterally facing and defining a lateral extent of the first seating position and wherein the vertical wall is laterally extendable between a stowed position defining a first volume in the first seating position and a deployed position defining a second volume in the first seating position that is less than the first volume.

2. The seat of claim 1, further comprising a second seat defining a second seating position laterally adjacent to the first seat and wherein the raised section is positioned between the first and second seats.

3. The seat of claim 1, wherein the vertical wall is slidably translatable between the stowed and deployed positions.

4. The seat of claim 1, further comprising a four-bar linkage connecting the vertical wall to the raised section.

5. The seat of claim 1, wherein the four-bar linkage comprises a planar four-bar linkage.

6. The seat of claim 1, further comprising a pneumatic bladder connecting the vertical wall to the raised section and an air pump adapted to selectively pump air into and pump air out of the pneumatic bladder to move the vertical wall between the stowed and deployed positions.

7. The seat of claim 1, further comprising a pleated wall section connecting the vertical wall to the raised section.

8. The seat of claim 7, wherein the pleated wall section comprises a plurality of bi-stable fold sections.

9. The seat of claim 1, further comprising a slide connecting the vertical wall section to the raised section, wherein the slide comprises selectively engageable detents corresponding to each of the stowed and deployed positions.

10. The seat of claim 1, further comprising a rotatable threaded rod engaging a threaded section in the raised section and having a distal end rotatably engaging the vertical wall.

11. A vehicle comprising:
a propulsion system; and
a vehicle passenger seat that includes:
a first seat defining a first seating position; and
a raised section positioned laterally adjacent the first seat, wherein the raised section includes a vertical wall laterally facing and defining a lateral extent of the first seating position and wherein the vertical wall is laterally extendable between a stowed position defining a first volume in the first seating position and a deployed position defining a second volume in the first seating position that is less than the first volume.

12. The vehicle of claim 1, wherein the vehicle passenger seat further includes a second seat defining a second seating position laterally adjacent to the first seat and wherein the raised section is positioned between the first and second seats.

13. The vehicle of claim 11, wherein the vertical wall is slidably translatable between the stowed and deployed positions.

14. The vehicle of claim 11, further comprising a four-bar linkage connecting the vertical wall to the raised section.

15. The vehicle of claim 11, wherein the four-bar linkage comprises a planar four-bar linkage.

16. The vehicle of claim 11, further comprising a pneumatic bladder connecting the vertical wall to the raised section and an air pump adapted to selectively pump air into and pump air out of the pneumatic bladder to move the vertical wall between the stowed and deployed positions.

17. The vehicle of claim 11, further comprising a pleated wall section connecting the vertical wall to the raised section.

18. The vehicle of claim 17, wherein the pleated wall section comprises a plurality of bi-stable fold sections.

19. The vehicle of claim 11, further comprising a slide connecting the vertical wall section to the raised section, wherein the slide comprises selectively engageable detents corresponding to each of the stowed and deployed positions.

20. The vehicle of claim 11, further comprising a rotatable threaded rod engaging a threaded section in the raised section and having a distal end rotatably engaging the vertical wall.
